(19) United States
(12) Patent Application Publication
(10) Pub. No.: US 2025/0333002 A1
(43) Pub. Date: Oct. 30, 2025

(54) MOVABLE RAISED FLOOR STORAGE SYSTEM

(71) Applicant: Thor Tech, Inc., Elkhart, IN (US)

(72) Inventors: Marcel Schmitz, Gamlen (DE); Andreas Weiber, Bassenheim (DE)

(73) Assignee: Thor Tech, Inc., Elkhart, IN (US)

(21) Appl. No.: 19/188,421

(22) Filed: Apr. 24, 2025

(30) Foreign Application Priority Data
Apr. 25, 2024 (DE) 10 2024 111 626.9

(51) Int. Cl. B60R 7/04

(52) U.S. Cl. CPC B60R 7/04

(57) ABSTRACT

The invention relates to a storage space system for a recreational vehicle with a double floor, which has an underbody and an upper floor spaced apart therefrom in the height direction, the storage space system being arranged in a storage space between the upper floor and the underbody, and wherein the storage space system can be reached from a vehicle interior through an opening in the upper floor, the storage space system having a frame which can be moved along a sliding direction and which is used to accommodate at least one row of at least two receptacles, in particular in the form of boxes. The invention further relates to a recreational vehicle.

### CROSS-REFERENCE TO RELATED APPLICATIONS

This application claims priority to German application No. 10 2024 111 626.9 filed Apr. 25, 2024, the disclosure of which is hereby incorporated by reference in its entirety.

### FIELD

The invention relates to a storage space system for a recreational vehicle with a double floor, which has an underbody and a top floor spaced upwards therefrom in the height direction, the storage space system being arranged in a storage space between the top floor and the underbody. The invention further relates to a recreational vehicle with such a storage space system.

### BACKGROUND

Due to the resulting vehicle weight, different recreational vehicles are equipped with a tandem axle, which enables more even weight distribution. The arrangement of the rear axles, designed as a tandem axle, enables storage space to be provided in the height direction above the axles. It is not possible to utilize the storage space between a tandem axle on the side of the recreational vehicle. Therefore, this space can only be accessed from above or from the living room or from the rear of the recreational vehicle. A rear garage is usually provided in the rear of the recreational vehicle.

Accessing the above-mentioned storage space from the garage is problematic because a garage is usually loaded with a large number of items. The garage must always be emptied before using the storage space in the tandem axle area. In addition, the storage space is significantly larger than a possible floor opening in the living room above the top floor. This means that the full extent of the storage space can only be accessed with great difficulty.

It is therefore the object of the present invention to create a storage space system and a recreational vehicle that enable simple and complete utilization of storage space in a double floor, particularly in the area of a tandem axle.

### SUMMARY

The invention achieves this object with the features of claims 1 and 9. Advantageous refinements are specified in the subclaims and the description.

According to one aspect of the present invention, a storage system for a recreational vehicle with a raised floor is provided. The raised floor has a subfloor and a top floor that is spaced upwards in the height direction. The top floor of the double floor can form a floor or subsurface for a room, for example a living room, of the recreational vehicle.

The storage space system is advantageously arranged in a storage space between the top floor and the underfloor. The storage system is accessible from a vehicle interior through an opening in the top floor. The opening or bottom opening can therefore be arranged above the storage system. The storage space system is advantageously not accessible from one side of the vehicle or from the rear of the recreational vehicle, but only through the opening in the top floor.

According to the invention, the storage space system has a frame which can be displaced along a sliding direction and which is suitable for holding at least one row of at least two receptacles. The receptacles can be designed, for example, in the form of boxes, such as Euroboxes.

According to a further aspect of the invention, a recreational vehicle is provided which has a storage space system according to the invention.

The recreational vehicle can preferably be a vehicle with a double axle or a tandem axle, with storage space being provided above these rear axles. The subfloor of the raised floor can limit the storage space downwards in the direction of the axes. The top floor can limit the storage space towards another room, such as a living room or lounge. In addition, the top floor can form the floor or an accessible surface for the space above the storage space. The top floor can be designed, for example, as a walking floor.

The relative terms, above, above, below, below and the like refer to a height direction of the vehicle which is oriented transversely to the direction of travel. The direction of travel is preferably parallel to the length direction or longitudinal direction of the vehicle. The axes of the tandem axle of the vehicle are spaced apart from one another in the longitudinal direction, for example.

The vehicle can be designed, for example, as a recreational vehicle. Such a vehicle can be designed as a mobile home, in particular a partially integrated or fully integrated mobile home, or panel van or camper van, or as a travel trailer (caravan). The vehicle can therefore be designed as a driven vehicle or as a non-driven vehicle.

Due to the possibility of moving the frame of the storage space system, a left and right side of the storage space can be operated and reached through a floor opening that is relatively small compared to the dimensions of the storage space. For example, the left side of the storage space can be a driver's side and the right side of the storage space can be a passenger side of the recreational vehicle.

When a box is removed from the frame, other boxes remaining on the frame can be moved on the frame and can therefore be accessed particularly easily and intuitively. This ensures that when one box is removed, all other boxes on the frame are directly accessible. The storage space can be optimally utilized with easy operation and handling.

In addition to the particularly ergonomic and easy accessibility of the entire storage system and the access to the storage space from the living room side, the storage space system according to the invention enables traffic-safe stowage of objects in a closed storage space and in boxes that are secured on the frame against moving.

The movable frame can be operated particularly easily and ergonomically through the opening in the top floor if the frame has at least one handle, which at least partially projects beyond the at least one receptacle in the height direction. Preferably, the displaceable frame is designed to be displaceable using the handle.

According to a further exemplary embodiment, the opening or bottom opening in the top floor can be closed with a lid. The lid can be a hinged lid which can be pivoted or folded relative to the top floor. Alternatively, the lid can be completely removable from the opening to expose the opening. Such a lid or insert lid can close the opening by inserting it into a recess in the top floor provided for this purpose. Depending on the design, the lid and/or the top panel can be provided with locking means in order to avoid unintentional opening or removal of the lid.

In a further embodiment, the displaceable frame can be locked to the lid via the handle and/or via a section of the frame. This measure makes it technically particularly easy to lock the frame while driving. The handle of the frame or a section of the frame can protrude at least partially into the lid or a section of the lid and interact with the lid in a positive or frictional manner in order to dampen or prevent displacement in the sliding direction.

In a further embodiment, the displaceable frame can be locked at the opening via the handle and/or via a section of the frame. As a result, locking means can be provided, which are arranged, for example, on a side of the top floor facing the storage space in the area of the opening, in order, for example, to prevent the frame from moving while the recreational vehicle is traveling.

A locking means can be designed, for example, in the form of a locking plate, which can be attached to the top floor. The locking means can further comprise a locking bolt which is attached to the frame or the handle of the frame or a section of the frame. Depending on the design, the section of the frame can be designed as a locking bolt with a corresponding receptacle. The locking bolt can interact with the locking plate in a form-fitting manner in order to prevent a relative movement between the frame and the opening of the top floor. The locking bolt can be spring-mounted and automatically snap into the locking plate in the form of a latch. Preferably, the locking bolt can be released through the opening if it is desired to move the frame in the sliding direction.

Through these configurations, the storage containers and the luggage stored therein can be safely stowed away by automatic locking when the bottom opening is closed.

According to a further embodiment, the opening in the top floor has a dimension which is larger than a dimension of a receptacle. Advantageously, the opening in the top floor is dimensioned such that exactly one receptacle can be removed through the opening. As a result, each receptacle can be lifted through the opening into or out of the storage space. The dimensions of the opening remain minimal due to this measure, so that the furnishing and use of the space above the storage space are affected as little as possible. For example, the opening in the top floor has a shape adapted to the shape of the receptacle, with only a slightly larger circumference, so that there is sufficient play when removing a receptacle (e.g. 5 to 30 mm).

The storage space can be used particularly efficiently if the receptacles are arranged on the frame in at least two rows, each with at least two receptacles. The rows advantageously run in the sliding direction of the frame. This allows four receptacles or more receptacles to be inserted and stored in the frame. An inserted receptacle can be moved particularly easily within a row. Depending on the design, receptacles can also be swapped between two rows or moved on the frame. For this purpose, the frame can have a base or a frame, which can hold the receptacles at least on the edge.

The frame can include a bottom boundary that can prevent the receptacles from slipping over an edge of the frame.

According to a further exemplary embodiment, at least one receptacle in a row on the frame can be displaced on the frame at least transversely to the sliding direction of the frame. With this measure, after a receptacle has been removed from the frame, the adjacent receptacle in the row can be moved into a vacant gap within the row. Such a procedure can enable sorting of the receptacles and, if necessary, ergonomic removal of all receptacles from the storage space.

The at least one receptacle can be moved particularly easily on the frame, regardless of its weight, if it can be moved transversely to the sliding direction of the frame on a rail system or on a frame base of the frame, in particular by sliding. To enable the receptacle to slide on the frame base, the frame base and/or the at least one receptacle can be provided with a coating that minimizes friction between the receptacle and the frame base.

According to a further embodiment, the frame is mounted on rails and/or on rollers in the storage space so that it can be moved along the sliding direction. As a result, the frame can be moved in a form completely loaded with receptacles or in an empty form or without a receptacle with a particularly low amount of force. The rails and/or rollers can be designed, for example, as a pull-out system. End stops can also be provided to limit the movement of the frame within the available storage space.

The frame can be made, for example, from metal and/or wood and/or a fiber composite material. Depending on the design, the frame can have metal profiles, for example aluminum profiles, or can be constructed entirely from such metal profiles. The frame base can be flat and have struts to form the rows that are designed to accommodate the receptacles. A section of the frame can extend in the height direction and can be used as a handle or on which a handle can be attached. The frame can preferably be arranged between the axles of the recreational vehicle in the storage space.

According to an exemplary embodiment of the recreational vehicle, the sliding direction of the storage space system is oriented transversely to the direction of travel. As a result, a relative movement of the frame when accelerating and braking the recreational vehicle can be avoided.

According to a further embodiment of the recreational vehicle, the storage space is arranged in the height direction above at least one vehicle axle, in particular a tandem axle. This allows access to a previously unusable or difficult-to-use space between the axes.

### BRIEF DESCRIPTION OF THE DRAWINGS

The invention will now be described in more detail with reference to the accompanying drawings. Shown in the drawings:

FIG. 1 is a perspective view of a storage space system installed in a recreational vehicle according to an embodiment of the invention;

FIG. 2 is a perspective view of a frame of the storage system from FIG. 1;

FIG. 3: a perspective view of a frame of a storage system according to a further embodiment of the invention;

FIG. 4: a perspective view of a storage system with a receptacle;

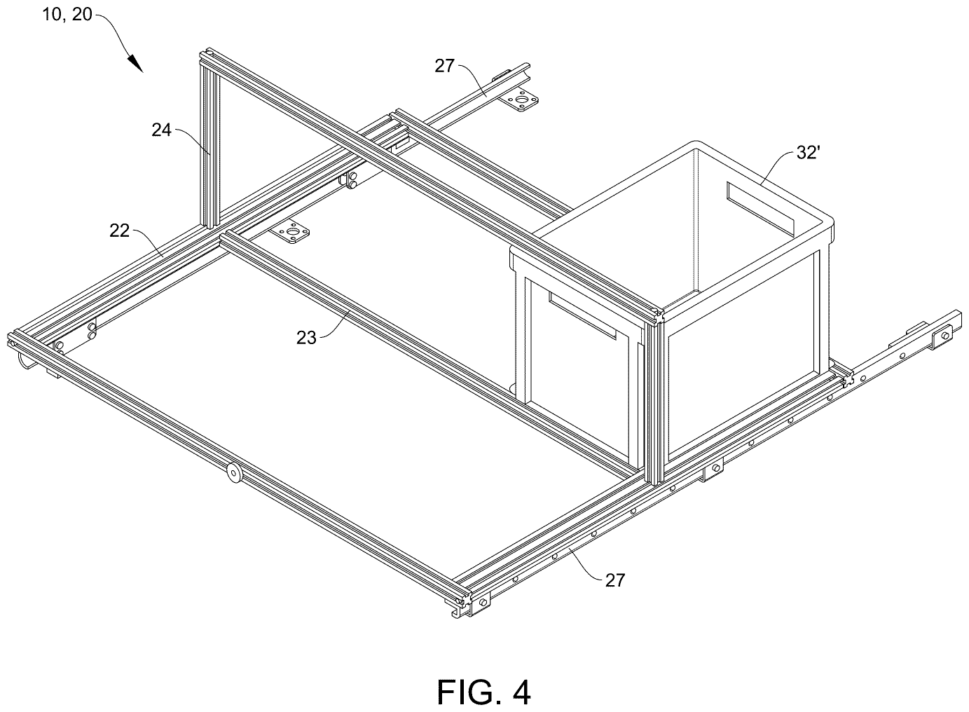

FIG. 5: a perspective view of a storage space system completely loaded with storage containers.

### DETAILED DESCRIPTION

In the figures, identical or corresponding elements are marked with the same reference numerals. Factors such as numerical values, shapes, components, positions of components, and the manner in which the components are connected to each other are merely illustrative and not restrictive. Different scales are sometimes used in the drawings for reasons of clarity and to improve visibility.

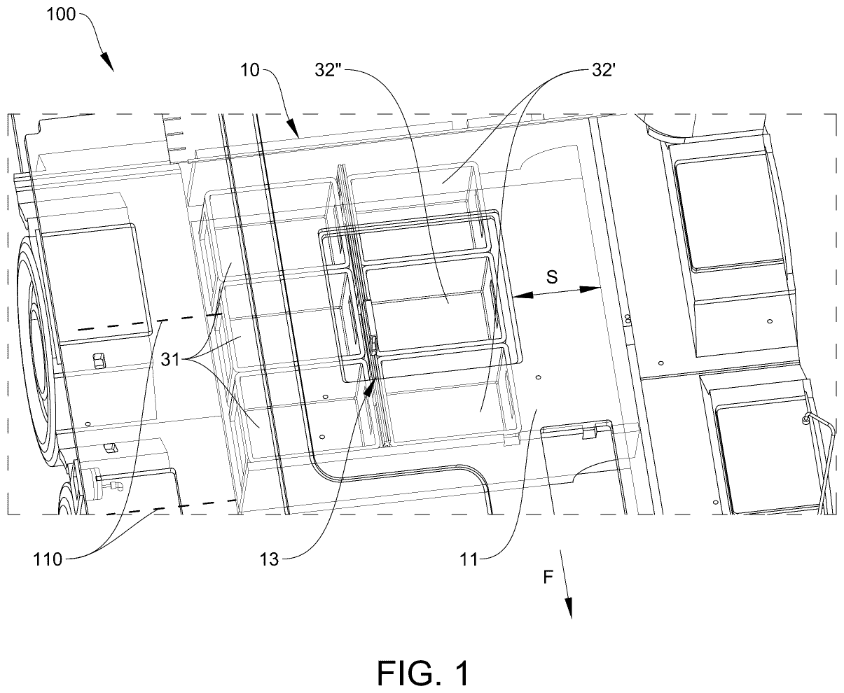

FIG. 1 shows a perspective view of a storage space system 10 installed in a recreational vehicle 100 according to an embodiment of the invention. FIG. 1 shows a rear area of the recreational vehicle 100, which has a tandem axle 110.

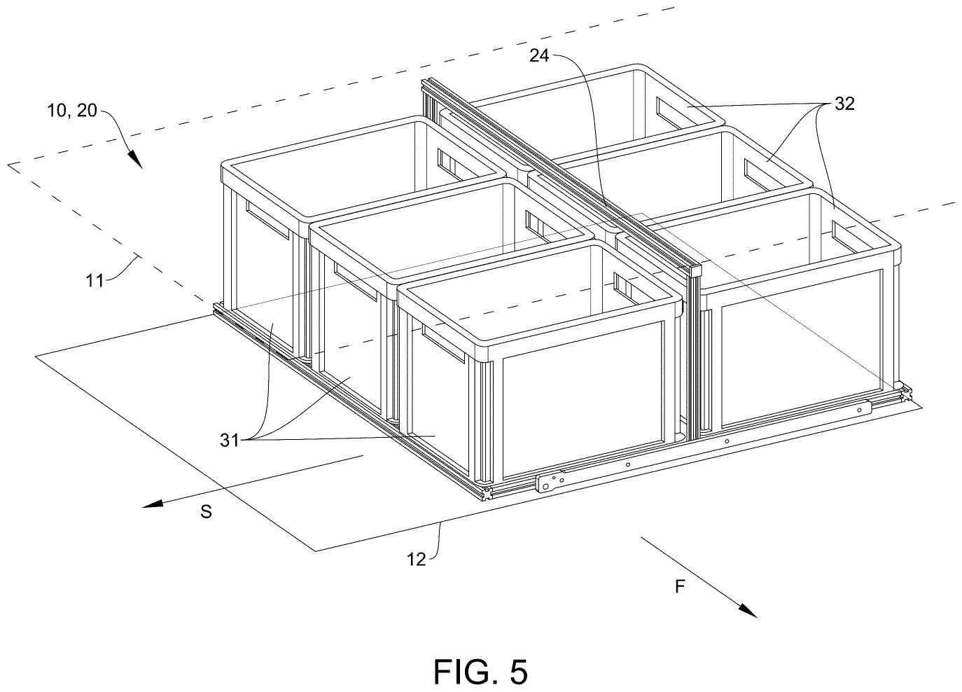

In the area of the tandem axle 110, the storage space system 10 has a double floor 11, 12. In the exemplary embodiment shown, the double floor 11, 12 consists of a top floor 11 and a bottom floor 12 (see FIG. 5). The top floor 11 is designed as a walking floor of a vehicle interior 120 of the recreational vehicle 100 and is walkable.

The storage space system 10 can be reached from the vehicle interior 120 through an opening 13 or floor opening in the top floor 11. To illustrate the storage space system 10, a lid or a floor hatch of the opening 13 is removed and the top floor 11 is shown transparent.

The storage space system 10 has a frame 20 which can be displaced along a sliding direction S and which is suitable for holding at least one row of at least two receptacles 31, 32. In the exemplary embodiments shown, for the sake of clarity, frames 20 are illustrated with two rows each. A first row can accommodate three receptacles 31 from the first row and a second row can accommodate three receptacles 32 from the second row.

The receptacles 31, 32 are designed, for example, in the form of Euroboxes. In FIG. 1, both rows are completely equipped with receptacles 31, 32. The frame 20 is shifted in the sliding direction S in such a way that a receptacle 32 of the second row can be removed and/or reached through the opening 13 in the top floor 11.

The sliding direction S of the frame 20 is aligned transversely to a direction of travel F of the recreational vehicle 100.

To remove the receptacles 31, 32 through the opening 13, the frame 20 can be moved in the transverse direction or sliding direction S. After a middle receptacle 32″ has been removed, outer receptacles 32′ can be moved over the frame 20 in the direction of travel F and thus also removed. When loading the storage space system 10, the procedure can be reversed. 4 shows, for example, a perspective view of a storage space system 10 with an inserted receptacle 32. The receptacle 32 can be inserted into a second row and moved in the direction of travel F in such a way that further receptacles 32 can be placed on the frame base 22. 5, for example, shows a perspective view of a storage space system 10 completely loaded with receptacles 31, 32.

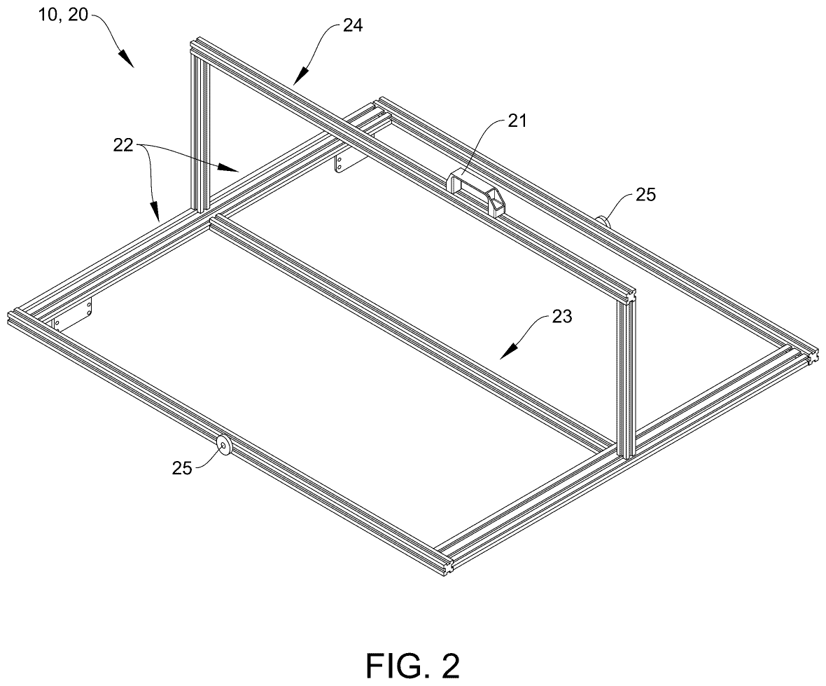

The frame 20 is, for example, made of metal profiles, in particular aluminum profiles. FIG. 2 illustrates the frame 20 of the storage system 10 with a handle 21 in a perspective view.

The frame 20 has a frame base 22, which is flat and runs adjacent to the underbody 12. The frame base 22 also has a strut 23. The frame base 22 with the strut 23 forms a base for the rows of receptacles 31, 32. The receptacles 31, 32 can be moved on the frame base 22 by sliding. For this purpose, the metal profiles that form the frame base 22 and the strut 23 can act as a base.

A vertical section 24 of the frame 20 extends in a height direction H. In the exemplary embodiment shown, the handle 21 is attached to the section 24. In the sliding direction S, magnets 25 are arranged on the frame base 22 in order to lock the frame 20 in its end positions or end stops. This measure enables easier loading and unloading of the frame 20 and/or the receptacles 31, 32. The magnets 25 can strike against end stops 26 in the raised floor 11, 12 and adhere to them magnetically.

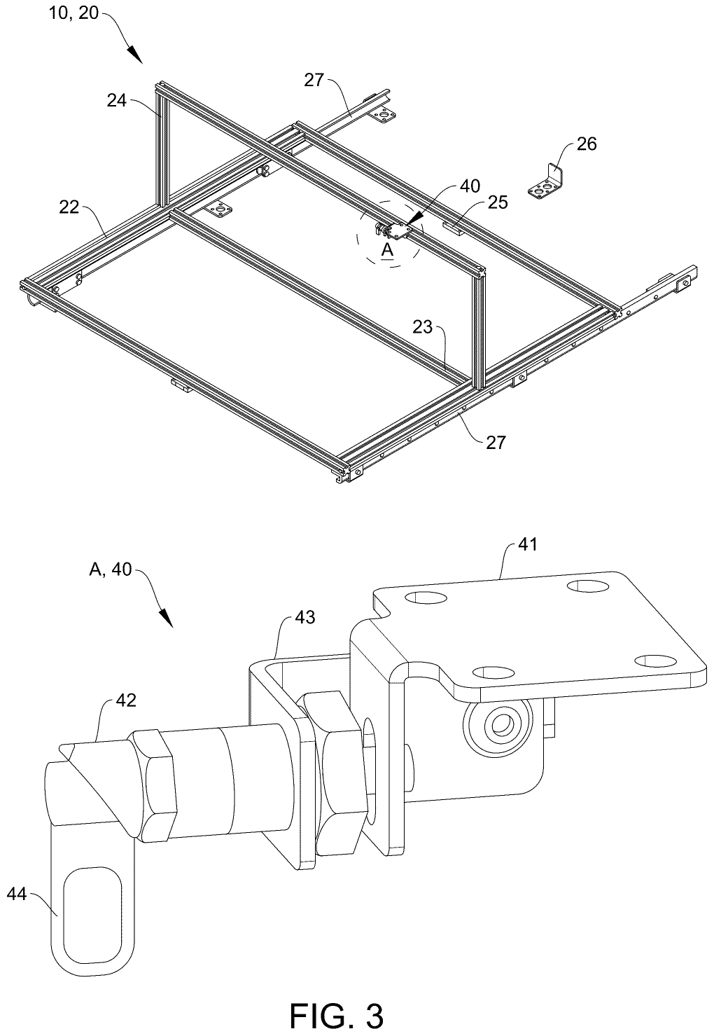

FIG. 1 and FIG. 3 show the frame 20 in a first end position. FIG. 5 shows the frame 20 in a second end position. In the first end position, the receptacles 32 of the second row and in the second end position the receptacles 31 of the first row can be reached through the opening 13 in the top floor 11.

FIG. 3 shows a perspective view of a frame 20 of a storage system 10 according to a further embodiment of the invention. In contrast to the exemplary embodiment already shown, the frame in FIG. 3 is equipped with a locking means 40 instead of a handle 21.

The locking means 40 is arranged on the section 24 of the frame 20 extending in the height direction H. The section 24 can be used as a handle to move the frame 20 through the opening 13. Preferably, the opening 13 can be dimensioned such that in the first end position and in the second end position of the frame 20, the section 24 and/or the handle 21 are within the dimensions of the opening 13.

In the exemplary embodiment shown in FIG. 3, the locking means 40 has a locking plate 41 and a locking bolt 42 with a receptacle 43 of the locking bolt 42. The locking means 40 is illustrated in a detailed view A of FIG. 3. The frame 20 can be fixed during travel by the locking means 40 in order to avoid movement of the frame 20 along the sliding direction S.

The locking bolt 42 is resiliently arranged within the receptacle 43. The receptacle 43 is designed as a bracket and is attached to the section 24 of the frame 20. The locking plate 41 can, for example, be attached to an underside of the top panel 11. The locking bolt 42 can interact positively with the locking plate 41 and block a relative movement between the locking plate 41 and the frame 20. Through the opening 13, the locking bolt 42 can be pulled out of the locking plate 41 on a handle section 44 and the frame 20 can be moved again.

The frame 20 is connected to the underbody 12 by two rails 27 and can be moved along the sliding direction S with the aid of the rails 27. The rails 27 are designed as rolling guides.

The respective fastenings of the rails 27 and the locking means 40 can be adjusted via non-numbered elongated holes in order to enable the frame 20 and the locking even in the event of deviations in the structure.

1. A storage space system for a recreational vehicle, the storage space system comprising:
a double floor, the double floor comprising an underbody and an upper floor spaced upwards therefrom in a height direction (H), the storage space system being arranged in a storage space between the upper floor and the underbody, and wherein the storage space system extends from a vehicle interior through an opening and can be reached in the upper floor, and
a frame displaced along a sliding direction(S) and the frame is suitable for holding at least one row of at least two receptacles in particular in the form of boxes.

2. The storage space system according to claim 1, wherein the frame has at least one handle or a vertical section which projects beyond the at least two receptacle in the height direction (H) at least in some areas, the frame being designed to be displaceable with the aid of the handle or the vertical section.

3. The storage space system according to claim 2, wherein the opening can be closed with a lid, and wherein the frame can be locked on the lid or on the opening via the at least one handle or via the vertical section of the frame.

4. The storage space system according to claim 1, wherein the opening in the upper floor has a dimension which is larger than a dimension of the at last two receptacles, in particular so large that exactly one of the at least two receptacles can be removed through the opening.

5. The storage space system according to claim 4, wherein the at least two receptacles are arranged in at least two rows, each with the at least two receptacles on the frame, the at least two rows running in the sliding direction(S) of the frame.

6. The storage space system according to claim 5, wherein at least one of the two receptacles in a row on the frame can be displaced on the frame at least transversely to the sliding direction(S) of the frame.

7. The storage space system according to claim 6, wherein the at least one of the two receptacles is displaceable transversely to the sliding direction(S) of the frame on a rail system or on a frame base of the frame, in particular by sliding.

8. The storage space system according to claim 1, wherein the frame is mounted on rails or on rollers in the storage space so as to be displaceable along the sliding direction(S).

9. A recreational vehicle having a storage space system according to claim 1.

10. The recreational vehicle according to claim 9, wherein the sliding direction(S) of the storage space system is aligned transversely to a direction of travel (F).

11. The recreational vehicle according to claim 9, wherein the storage space is arranged in the height direction (H) above at least one vehicle axle, in particular a tandem axle.
